(19) United States
(12) Patent Application Publication
(10) Pub. No.: US 2024/0317959 A1
(43) Pub. Date: Sep. 26, 2024

(54) POLYMERIC NANOCOMPOSITE FOAMS

(71) Applicant: NewSouth Innovations Pty Limited, Sydney (AU)

(72) Inventors: Per B. ZETTERLUND, Sydney (AU); Vipul AGARWAL, Sydney (AU); Rabiatul Adawiah MAT NOOR, Sydney (AU)

(21) Appl. No.: 18/568,125

(22) PCT Filed: Jun. 10, 2022
(86) PCT No.: PCT/AU2022/050577

§ 371 Date: May 10, 2024

(30) Foreign Application Priority Data
Jun. 10, 2021 (AU) 2021901744

(51) Int. Cl. C08J 9/28; C08J 3/215; C08J 9/00; C08K 3/04

(52) U.S. Cl. CPC C08J 9/283; C08J 3/215; C08J 9/0071; C08K 3/042; C08J 2201/0484; C08J 2325/14; C08J 2333/10; C08K 2201/001

(57) ABSTRACT

The present invention relates to a method of forming a foam material, the method comprising the steps of: a) providing an aqueous dispersion comprising polymer particles and a functional filler dispersed in the aqueous phase, and b) lyophilising the aqueous dispersion, to thereby form the foam material. The invention also relates to a foam material produced by the method, and uses of the foam material, for example in anti-static casings, electrode materials, support elements, insulators, catalysis, as membranes for water filtration, implantable materials for biomedical engineering and electromagnetic interference shielding.

### FIELD OF THE INVENTION

The present invention relates to polymeric nanocomposite foams loaded with functional fillers and methods for preparing such foams. In some preferred embodiments, the invention relates to the formation of polymer foams loaded with fillers selected from graphene oxide (GO) and/or reduced graphene oxide (rGO) or graphene quantum dots (GQDs). Some preferred nanocomposite foams of the invention can be electrically conductive, and therefore will find use in a large number of applications, such as electrode materials, or as bioimplants or catalytic interfaces, etc. However, it will be appreciated that the invention is not limited to these particular fields of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

A foam is a porous material formed by trapping pockets of gas in a solid. The two phases, solid and gas, provide unique properties to foam materials, such as light weight, mechanical, thermal, or electrical properties (among others), and may also provide materials with superior performance as support elements or as insulators.

The market for foam materials is exceedingly diverse, owing to the diversity of foam materials and applications, and is large. By way of example, it is estimated that the market size for polyurethane foam is $US55 bn with a reported compound annual growth rate (CAGR) of 8.5%. Also, the conductive foam market is estimated to have a market size of $US 3.5 bn (as at 2018) with a CAGR of 4%.

A typical approach to the preparation of a polymeric nanocomposite foam material is based on synthesis of a 3D foam from a polymer matrix material, and requires foaming and/or blowing agents to induce porosity in the polymer matrix. For such foams, this matrix is converted into the actual foam, or in other words the blowing agents are used to introduce porosity into the polymer matrix material. Generating foams in this way either requires an additional step and/or additional chemicals, which is undesirable. It will be appreciated that such an approach cannot produce a foam from a colloidal dispersion of polymer particles.

As the skilled person will appreciate, a colloid has a dispersed phase (i.e., the suspended polymeric particles) and a continuous phase (i.e., the medium of suspension), whereby the dispersed phase particles typically have a diameter of approximately 1 nanometre to 1 micrometre. Given that a significant proportion of the polymers that are synthetically prepared worldwide are prepared as a colloidal dispersion, it would be advantageous to be able to prepare a foam directly from a colloidal dispersion. To the best of the inventors' knowledge, foams prepared from colloidal dispersions have not yet been reported in the literature.

It is generally acknowledged that there is poor compatibility between some polymers and various functional fillers. For example, a functional material such as graphene may be difficult to evenly disperse in some polymers, especially when the polymer is foamed by prior art processes. A number of approaches have been described to improve the compatibility between graphene and a polymer matrix, such as covalent functionalisation of graphene and exploitation of IT-IT or electrostatic interactions between graphene sheets and polymer chains. An alternative strategy involves use of graphene oxide (GO). GO is an oxidised form of graphene, wherein a number of C—C double bonds within a graphene sheet have been oxidised to various functional groups such as hydroxy, carbonyl, epoxy, or carboxylic acid. GO is relatively easier to work with due to its improved solubility, but unlike graphene it does not exhibit electrical conductivity. However, GO may be reduced back to “reduced GO” (rGO) to improve its conductive or structural properties. A polymeric nanocomposite foam material comprising GO (and/or rGO/GQDs) may compete with traditional polyurethane foams, amongst others. It would also be advantageous to prepare modified foams which are loaded with fillers, which are also directly produced from a colloidal dispersion.

There is a need for strategies that mitigate at least one of the problems outlined above. For example, it would be a significant advance in the art to be able to prepare polymeric nanocomposite foams directly from colloidal dispersions, and to improve compatibility of functional materials/fillers such as graphene, GO, rGO, GQDs, etc, loaded into those polymeric foams. It would also be an advance in the art to prepare polymeric foams where functional materials/fillers are more evenly dispersed throughout the foam material, and to do so without the use of a foaming or blowing agent.

It is an object of the present invention to overcome or ameliorate one or more the disadvantages of the prior art, or at least to provide a useful alternative.

### SUMMARY OF THE INVENTION

According to a first aspect of the invention there is provided a method of forming a foam material, the method comprising the steps of:
a) providing an aqueous dispersion comprising polymer particles and a functional filler dispersed in the aqueous phase, and
b) lyophilising the aqueous dispersion, to thereby form the foam material.

A significant proportion of the world's polymers are produced via emulsion polymerisation. To produce a foam from these polymers, additional processing is required to isolate the polymer and undertake traditional foam production methods, which typically use blowing agents, etc. The present invention provides a convenient and efficient method to produce nanocomposite foams directly from a colloidal dispersion. This is a significant advance in the art, and uses readily available technologies (i.e., freeze-drying equipment). Furthermore, it has been surprisingly found that the method of the invention enables a wide variety of functional fillers to be incorporated into the final foamed material. Yet further still, it has been surprisingly found that the functional filler can be relatively evenly dispersed throughout the nanocomposite foam. Any functional filler which is capable of being dispersed in the aqueous phase of a colloidal dispersion can be utilised with the method of the present invention. The present invention provides a technology platform which enables the efficient production of nanocomposite foams that can be tailored to suit a wide variety of applications. For example, electrically conductive functional fillers may be used in a range of concentrations in order to tune the electrical properties of the nanocomposite foam. Additionally, it is possible to combine different colloidal dispersions of different polymers to create novel nanocomposite foams, thereby enabling control over mechanical properties of the produced foams, and other physical properties of the foams.

It will be appreciated that there are a number of methods to produce polymer particles which are suitable for the first aspect of the invention. For example, in one method polymer particles can be synthetically prepared (polymerised) from monomer, and in another example a preformed polymer can be dissolved in a solvent and then formed into an aqueous dispersion of polymer particles. Other methods to form polymer particles will be well known to the person skilled in the art.

In an embodiment of the invention, the polymer particles in step (a) are produced by:
(i) providing a monomer;
(ii) emulsifying the monomer to provide an emulsion comprising stabilised monomer droplets in an aqueous phase; and
(iii) polymerising the monomer to form said polymer particles.

In an embodiment of the invention, step (a) is provided by:
(i) dissolving a polymer in a solvent to form a first solution;
(ii) combining the first solution with the functional filler dispersed in the aqueous phase; and
(iii) forming an aqueous dispersion of said polymer, preferably by sonication, to produced said polymer particles.

It will be appreciated that evaporation of the solvent may be required.

In an embodiment of the invention, the method further comprises a step of adding a surfactant to assist with emulsification of the monomer or stability of the aqueous dispersion of said polymer. A preferred surfactant is sodium dodecyl sulfate. However, other surfactants will be well known to the person skilled in the art.

In an embodiment of the invention, the functional filler is graphene oxide (GO), reduced graphene oxide (rGO), graphene quantum dots (GQDs), carbon nanotubes (CNTs), carbon black, carbon dots, gold or silver nanoparticles, polymer fibres or combinations thereof.

In an embodiment of the invention, the method further comprises a step of reducing the GO to form rGO prior to step (b), preferably chemically reduced.

In an embodiment of the invention, the method further comprises a step of reducing the GO in situ to form rGO after step (b).

In an embodiment of the invention, a method of treating a colloidal dispersion is provided, wherein GO is reduced to produce rGO in situ by using a reducing agent.

In an embodiment, the polymer particles are comprised of a homopolymer, a copolymer, or a combination thereof. The polymer may be crosslinked.

In an embodiment, the polymer particles are comprised of polymers selected from polystyrene, poly (meth)acrylate, polyolefins, and polyesters or any combination thereof.

In an embodiment, the polymer particles comprise two or more different types of polymers.

Examples of thermoplastic polymers are the following: homopolymers and copolymers (including elastomers) of one or more alpha-olefins, such as ethylene, propylene, 1-butene, 3-methyl-1-butene, 4-methyl-1-pentene, 3-methyl-1-pentene, 1-heptene, 1-hexene, 1-octene, 1-decene and 1-dodecene, typically represented by polyethylene, polypropylene, poly-1-butene, poly-3-methyl-1-butene, poly-3-methyl-1-pentene, poli-4-methyl-1-pentene, ethylene and propylene copolymer, ethylene and 1-butene copolymer and propylene copolymer and 1-butene; copolymers (including elastomers) of an alpha-olefin with a conjugated or unconjugated diene, typically represented by copolymers of ethylene and butadiene and copolymers of ethylene and ethylidene norbornene, and polyolefins (including elastomers) such as copolymers of two or more alpha-olefins with a conjugated or unconjugated diene, typically represented by copolymers of ethylene, propylene and butadiene, copolymers of ethylene, propylene and dicyclopentadiene, copolymers of ethylene, propylene and 1,5-hexadiene and copolymer of ethylene, propylene and ethylidene-norbornene; copolymers of ethylene and a vinyl compound, such as copolymers of ethylene and vinyl acetate, copolymers of ethylene and vinyl alcohol, copolymers of ethylene and vinyl chloride, copolymers of ethylene and acrylic acid or of ethylene and methacrylic acid and copolymers of ethylene and (meth) acrylate; styrene copolymers (including elastomers) such as polystyrene, ABS, acrylonitrile and styrene copolymer, styrene and a-methylstyrene copolymer, styrene and vinyl alcohol, styrene and acrylates such as styrene and methyl acrylate, styrene and acrylate, butyl acrylate of styrene and butyl methacrylate, and of styrene and butadienes and cross-linked styrene polymers; and styrene block copolymers (including elastomers) such as styrene and butadiene copolymers and their hydrates and triblock copolymers of styrene, isoprene and styrene; polyvinyl compounds such as polyvinyl chloride, polyvinylidene chloride, vinyl chloride and vinylidene chloride copolymers, polymethyl acrylate and polymethylmethacrylate; polyamides such as nylon 6, nylon 6.6 and nylon 12; thermoplastic polyesters such as poly (ethylene terephthalate) and poly (butylene terephthalate); polyurethane; polycarbonate; poly (phenylene oxide) and the like; and hydrocarbon-based vitreous resins, including polycyclopentadiene type polymers and related polymers (copolymers, terpolymers); saturated mono-olefins such as vinyl acetate, vinyl propionate, vinyl versatate and vinyl butyrate and the like; vinyl esters, such as monocarboxylic acid esters, including methyl acrylate, ethyl acrylate, n-butyl acrylate, isobutyl acrylate, 2-ethylhexyl acrylate, dodecyl acrylate, n-octyl acrylate, phenyl acrylate, phenyl acrylate of methyl, ethyl methacrylate and butyl methacrylate, and the like; acrylonitrile, methacrylonitrile, acrylamide and mixtures thereof.

In an embodiment, the polymer particles have a glass transition temperature (Tg) in the range of about −65° C. to about 250° C.

According to a second aspect of the invention there is provided a foam material produced by the method according to the first aspect.

In an embodiment, the functional filler is GO and the foam material has an electrical conductivity of from 10⁻¹⁵ S.m⁻¹ to 10⁻⁵ S.m⁻¹.

In an embodiment, the functional filler is rGO and the foam material has an electrical conductivity of from 0.001 S.m⁻¹ to 10,000 S.m⁻¹.

In an embodiment, the foam material has a compressive strength of from 0.5 kPa to 150 kPa.

In an embodiment, the foam material has a Young's modulus of from 1 kPa to 5000 kPa.

According to a third aspect of the invention there is provided a foam material according to the second aspect of the invention, for use or when used in anti-static casings, electrode materials, support elements, insulators, catalysis, as membranes for water filtration, heat transfer materials, sound absorbing materials, implantable materials for biomedical engineering and electromagnetic interference shielding.

According to a fourth aspect of the invention there is provided use of a foam material according to the second aspect of the invention in anti-static casings, electrode materials, support elements, insulators, catalysis, as membranes for water filtration, heat transfer materials, sound absorbing materials, implantable materials for biomedical engineering and electromagnetic interference shielding.

Other aspects of the present invention will become apparent to those ordinarily skilled in the art upon review of the following description of specific embodiments of the invention.

### FIGURES

For a further understanding of the aspects and advantages of the present invention, reference should be made to the following detailed description, taken in conjunction with the accompanying figures.

FIG. 1 is a schematic diagram showing the general concept of forming a foam material from a latex comprising polymer particles and a functional filler.

FIG. 2 is a schematic diagram showing the general strategy to form coated polymer particles from monomer and GO via miniemulsion polymerisation.

FIG. 3 is a schematic diagram showing the blend-miniemulsion route to form GO-coated polymer particles comprising two different types of polymer particles.

FIG. 4 is a schematic diagram showing the physical mixing route to form a mixture of polymer particles and GO, wherein the polymer particles comprise a combination of two different monomers.

FIG. 5 is a schematic diagram showing the blend-physical mixing route, as an alternative strategy to form a mixture of polymer particles and GO comprising two (or more) different types of polymer particles.

FIG. 6 shows schematic diagrams for preparing a foam: (a) traditional approach; and (b) approach according to the present invention.

FIG. 7 shows a foam comprising coated polymer particles, compared to an Australian $2 coin: (a) top view; and (b) side view.

FIG. 8 shows a schematic diagram showing in-situ reduction of polymer/GO latexes and foam formation.

FIG. 9 shows a PEHMA/rGO foam formed from the method as shown in FIG. 7: (a) side view; and (b) top view.

FIG. 10 shows scanning electron microscope (SEM) images of foams prepared via the miniemulsion route: (a)-(b) poly(n-butyl acrylate)/GO surface; (c) poly(n-butyl acrylate)/GO cross section; (d)-(e) poly(ethyl acrylate)/GO surface; (f) poly(ethyl acrylate)/GO cross section; (g)-(h) poly(lauryl acrylate)/GO surface; (i) poly(lauryl acrylate)/GO cross section; (j)-(k) poly(ethyl hexyl methacrylate)/GO surface; (I) poly(ethyl hexyl methacrylate)/GO cross section; (m)-(n) poly(hexyl methacrylate)/GO surface; (o) poly(hexyl methacrylate)/GO cross section; (p)-(q) poly(benzyl acrylate)/GO surface; (r) poly(benzyl acrylate)/GO cross section; (s)-(t) poly(methyl acrylate)/GO surface; (u) poly(methyl acrylate)/GO cross section.

FIG. 11 shows scanning electron microscope (SEM) images of foams prepared via physical mixing: (a)-(b) poly(n-butyl acrylate)/GO surface; (c) poly(n-butyl acrylate)/GO cross section; (d)-(e) poly(ethyl acrylate)/GO surface; (f) poly(ethyl acrylate)/GO cross section; (g)-(h) poly(benzyl acrylate)/GO surface.

FIG. 12 shows stress-strain curves of polymer/GO foams with obtained from: (a) miniemulsion polymerisation; and (b) physical mixing.

FIG. 13 shows stress-strain curves of crosslinked polymer/GO foams made from various polymers, with 5% DVB used.

FIG. 14 shows stress-strain curves of polymer/rGO foams obtained from different polymer particles.

FIG. 15 shows schematic diagrams of polystyrene/GO foam formation.

FIG. 16 shows schematic diagrams of forming polymer/cGQD foam material via miniemulsion polymerisation and physical mixing.

FIG. 17 shows the comparison of particle size of polymer particles in the foam material obtained with 0 wt % and 1 wt % of SDS as surfactant, via miniemulsion polymerisation.

FIG. 18 shows photographs of polymer/cGQD foams obtained under different conditions via (a): miniemulsion polymerisation; and (b) physical mixing.

FIG. 19 shows the SEM images of St/BA/GQD foam and HMA/GQD foam.

FIG. 20 shows photographs of PEA/DVB/GQD and PSt/BA/GQD foams before and after freeze drying, with 20 wt % polymer/GQDs relative to water in the initial dispersion before foam formation, via miniemulsion polymerisation.

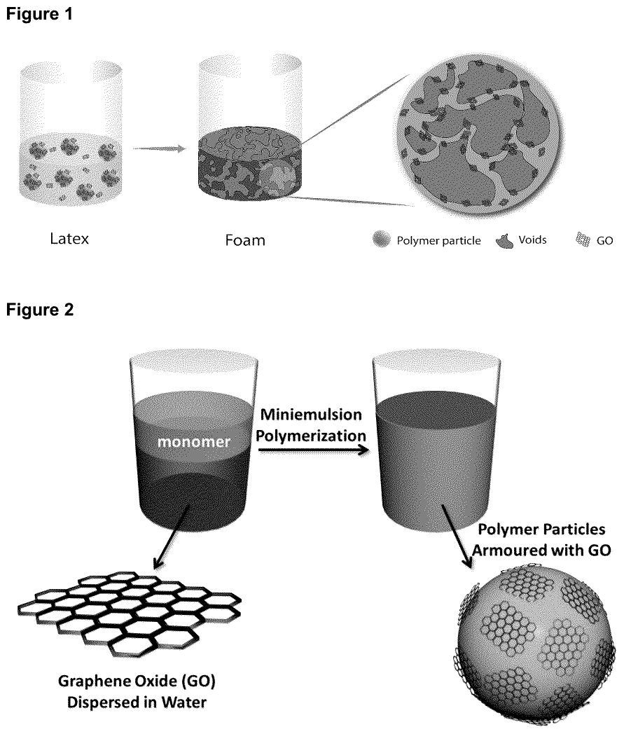

### DEFINITIONS

In describing and claiming the present invention, the following terminology will be used in accordance with the definitions set out below. It is also to be understood that the terminology used herein is for the purpose of describing particular embodiments of the invention only and is not intended to be limiting.

Unless defined otherwise, all technical and scientific terms used herein have the same meaning as commonly understood by those of ordinary skill in the art to which the invention belongs.

Unless the context clearly requires otherwise, throughout the description and the claims, the terms “comprise”, “comprising”, and the like are to be construed in an inclusive sense as opposed to an exclusive or exhaustive sense; that is to say, in the sense of “including, but not limited to”. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of.” In other words, with respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The terms “predominantly” and “substantially” as used herein shall mean comprising more than 50% by weight, unless otherwise indicated.

As used herein, with reference to numbers in a range of numerals, the terms “about,” “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, wt. % refers to the weight of a particular component relative to total weight of the referenced composition.

The term “and/or” used in the context of “X and/or Y” should be interpreted as “X,” or “Y,” or “X and Y.” Similarly, “at least one of X or Y” should be interpreted as “X,” or “Y,” or “both X and Y.”

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Terms like “preferably”, “commonly”, “significantly”, “typically”, and the like, when utilised, are not utilised to limit the scope of the claimed invention or to imply that certain features are critical, essential, or even important to the structure or function of the claimed invention. Rather, these terms are merely intended to identify particular aspects of an embodiment of the present disclosure or to emphasise alternative or additional features that may or may not be utilised in a particular embodiment of the present disclosure.

The complete disclosures of the patents, patent documents and publications cited herein are incorporated by reference in their entirety as if each were individually incorporated.

The term “blend-miniemulsion” means a blend of the products of miniemulsion polymerisation, e.g. polystyrene-GO particles and poly(butyl acrylate)-GO particles.

The term “coated” means that a polymer particle is covered with GO; in other words, the GO is located over the surface of the polymer particle.

The term “homopolymer” means that a polymer is made from only one type of monomer.

The term “copolymer” means that a polymer is made from more than one type of monomer, wherein the co-monomers may be arranged in a regular alternating fashion, or they may alternate in a random fashion. For example, if a polymer is made from two monomers, A and B, the copolymer may have a structure of A-B-A-B- . . . , A-A-B-B-A-A-B-B- . . . or other regularly repeating units, or it may be irregular with no discernible repeating pattern, such as A-A-B-A-B-B-B-B-A- . . . .

The term “dispersion” means a system wherein one or more types of solid particles, such as polymer particles, are distributed throughout a liquid phase (continuous phase). An “aqueous dispersion” is a liquid system in which very small solid particles are uniformly dispersed in water. These are two-phase liquid systems where one phase consists of finely divided particles of water insoluble, solid chemical products distributed throughout the second phase, which is water.

The term “emulsion” means a system wherein one or more liquids, which are immiscible with a continuous phase, are distributed throughout the continuous phase.

The term “latex” means a stable dispersion of polymer particles in water.

The term “miniemulsion” means a submicron (typical droplet diameter=50-1,000 nm) oil-in-water emulsion that is typically stable for a period ranging from hours to months. The oil droplets contain polymerisable monomers, and they may also contain preformed polymers, inorganic materials, surfactants, and solvents.

The term “miniemulsion polymerisation” means the process of converting monomer droplets into polymer particles. The term “emulsion polymerisation” is a type of radical polymerization that usually starts with an emulsion comprising water, monomer, and one or more surfactants, where polymer particles are formed in the continuous phase as opposed to directly from monomer droplets as in miniemulsion polymerisation.

The term “polymer particle” means a generally (but not always) spherical unit which is comprised of polymers. The particles of the present invention typically have a size (diameter) in the range of about 10 nm to about 2000 nm.

The term “solution” means a homogeneous mixture of two or more substances in a liquid. In such a mixture, a solute is a substance dissolved in another substance, known as a solvent. The term “aqueous solution” refers to a solution with water as a solvent. The term “foam material” means a porous composite material comprising a network of solid polymer and GO interspersed with voids, which are filled with a gas such as air.

The term “graphene oxide” (GO) means an oxidised form of graphene. Graphene is a planar allotrope of carbon, which forms a two-dimensional hexagonal mesh structure. Upon oxidation, functional groups such as epoxides, hydroxyl groups, carbonyl groups, and carboxylic acids are incorporated into the graphene structure in differing amounts and locations, depending upon the size and shape of the starting graphene sheet and the oxidation conditions.

The term “reduced graphene oxide” (rGO) means a reduced form of graphene oxide, wherein some or even many of the epoxide, hydroxyl, carbonyl and carboxylic acid groups of the GO have been reduced using chemical or other means. The graphene oxide is unlikely to be reduced back to pristine graphene, although this may be theoretically possible.

The term “graphene quantum dot” (GQD) means graphene nanoparticles with a size less than 100 nm. Graphene quantum dots (GQDs) typically consist of one or a few layers of graphene. They are typically chemically and physically stable, have a large surface to mass ratio and can be typically dispersed in water easily due to functional groups at the edges.

The term “freeze casting” refers to the controlled solidification of a solution, suspension, sol or gel, followed by the sublimation of the solvent (mostly commonly water) under reduced pressure, and subsequent densification by post-treatment. During the controlled solidification process, as the solvent solidifies, phase separation takes place, with the resulting solid phase (usually ice) serving as a template. For this reason, freeze casting is also commonly referred to as ice-templating. Afterwards, the solidified solvent template is removed by sublimation while the structural framework is retained, eventually yielding a well-shaped monolith. A key advantage of freeze-casting is its applicability to a wide range of materials, with diverse assembly units, or building-blocks, being utilized in such methods including nanoparticles, nanotubes, nanowires, nanofibers, nanosheets, nanoplatelets, polymer chains and macromolecules, so long as these can be stably dispersed. Another advantage is that various alterations to processing conditions may produce drastic changes in the obtained micro- and macrostructures of freeze-cast scaffolds. Microstructural properties of scaffolds, in terms of porosity and pore morphology (lamellar, honeycomb, cellular, radial etc.) can be tailored by chemical and physical methods, while diverse scaffold geometries at the macroscale can be achieved by combining freeze casting with other processing and shaping routes

The term “in-situ” means “in the reaction mixture”.

The term “sonication” is the application of vibrational energy in the ultrasonic frequency range (20 kHz to 1 MHZ) to efficiently mix aqueous solutions and suspensions.

The present specification uses the following abbreviations:
GO Graphene oxide
rGO Reduced graphene oxide
GQD Graphene quantum dot
CGQD Carboxylated graphene quantum dot
Pn-BA Poly(n-butyl acrylate)
PEA Poly(ethyl acrylate)
PLA Poly(lauryl acrylate)
PEHMA Poly(ethyl hexyl methacrylate)
PHMA Poly(hexyl methacrylate)
PBZA Poly(benzyl acrylate)
PMA Poly(methyl acrylate)
DVB Divinylbenzene
PSt Polystyrene
PSt/BA Poly (styrene-stat-n-butyl acrylate)
EGDMA Ethylene glycol dimethacrylate
TEGDA Tetra(ethylene glycol) diacrylate
VA-044 2,2′-Azobis[2-(2-imidazolin-2-yl)propane]dihydrochloride
KPS Potassium persulfate
ACPA 4,4′-Azobis (4-cyanopentanoic acid)

### DETAILED DESCRIPTION OF THE INVENTION

### Nanocomposite Foam Materials

The present invention relates to foam materials comprising polymer and a functional filler, for example GO (and/or rGO/GQDs). The resulting foam material having the functional filler can be considered as a nanocomposite.

Taking the example where the functional filler is GO, the GO sheets are introduced into the nanocomposite either by (i) miniemulsion polymerization in the presence of GO in the aqueous phase to generate a dispersion of polymeric (nano)particles at least partially coated with GO sheets, or (ii) mixing of an aqueous dispersion of polymeric (nano)particles and an aqueous dispersion of GO. It will be appreciated that this example references the functional filler as GO, but other functional fillers could be used in addition to GO, or instead of GO.

After provision of the aqueous dispersion comprising polymer particles and GO (or other functional filler), the dispersion is lyophilised to form the three-dimensional nanocomposite foam material. Notably, method (i) or (ii) does not involve use of any blowing agent or any other method such as salt leaching, to form the foam material. Properties, such as surface, physicochemical, morphological, mechanical, thermal and electrical properties of the foam materials are tuneable, as discussed previously. The tuning of properties may be undertaken by any number of ways, such as by changing the way the polymers are prepared, or changing the constituents of the polymer particles (for example by selection of different monomers, and different ratios of monomers, etc), or processing of the polymers after polymerisation, or cross-linking, or processing of the GO such as converting the GO to rGO, or changing the concentration of the polymer particles in the aqueous dispersion, or varying the size of the polymer particles, or varying the size or nature of the GO sheets, or inclusion of a surfactant, or any one or more of the foregoing. The person skilled in the art will be aware of how to vary any one or more of these parameters in order to obtain or tune the properties of the resulting nanocomposite foam of the invention.

The foam materials of the invention can find use in applications such as insulators, in catalysis, as membranes for water filtration, as electrode materials, as heat transfer materials, as sound absorbing materials, as an implantable material for biomedical engineering, or for electromagnetic interference shielding such as for defence or in the aviation industry.

### Polymer

### Monomers

Any monomer or combination of monomers may be used that, when polymerized, result in a polymer with a glass transition temperature (T_{g}) between about −65° C. and about 250° C. Suitable monomers include, but are not limited to, styrenes, acrylates and methacrylates. A person skilled in the art will be able to determine suitable styrene, acrylate and methacrylate monomers capable of forming a polymer with a suitable glass transition temperature and being useful in the present invention. Polymers having a Tg that fall within the range above are particularly suitable for making foam materials.

### Polymer Formation

The present invention comprises transforming an aqueous dispersion of polymer particles into a foam material, wherein the aqueous dispersion also contains a functional filler, such as GO (and/or rGO/GQDs). Prior to foam formation, the functional filler either coats the particles and/or is dispersed throughout the aqueous phase. Any method of preparing an aqueous dispersion of a polymer particle and functional filler may be used.

The monomer may be polymerised by any number of methods known in the art. The resulting polymer forms a dispersion in water. A typical polymerisation method is heterogeneous radical polymerisation, such as emulsion or miniemulsion polymerisation, or dispersion/suspension polymerisation.

For radical polymerisations, reactions are usually carried out in an inert atmosphere (to exclude oxygen). The reaction time and temperature will vary from one monomer to another, as well as due to other variables such as concentration or the initiator being used, as will be readily determined by one of skill in the art. Radical polymerisations are typically initiated by use of an azo compound, such as azobisisobutyronitrile (AIBN). Other initiators include 2,2′-Azobis[2-(2-imidazolin-2-yl)propane]dihydrochloride (VA-044), potassium persulfate (KPS) and 4,4′-Azobis (4-cyanopentanoic acid) (ACPA) Other initiators would be well known to the person skilled in the art.

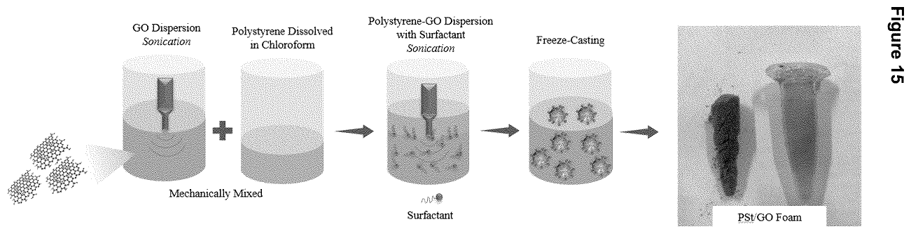

In some embodiments of the invention, a polymer can be dissolved in a solvent and the dissolved polymer can then be mixed with an aqueous dispersion of functional filler(s), such as GO and/or rGO/GQDs, to form a polymer particle/GO (and/or rGO/GQDs) aqueous dispersion, as shown in FIG. 15.

### Glass Transition Temperature

Glass transition temperature (T_{g}) is an indication of the temperature at which an amorphous material such as a polymer (or amorphous regions within a semicrystalline material/polymer) changes from a “glassy” state into a viscous/rubbery state as the temperature is increased.

In some embodiments of the invention, the polymer has a T_{g} of between about −65° C. and about 250° C. For example, the polymer may have a T_{g} of between about −65° C. and about −60° C., or about −60° C. and about −55° C., or about −55° C. and about −50° C., or about −50° C. and about −45° C., or about −45° C. and about −40° C., or about −40° C. and about −35° C., or about −35° C. and about −30° C., or about −30° C. and about −25° C., or about −25° C. and about −20° C., or about −20° C. and about −15° C., or about −15° C. and about −10° C., or about −10° C. and about −5° C., or about −5° C. and about 0° C., or about 0° C. and about 5° C., or about 5° C. and about 10° C., or about 10° C. and about 15° C., or about 15° C. and about 20° C., or about 20° C. and about 25° C., or about 25° C. and about 30° C., or about 30° C. and about 35° C., or about 35° C. and about 40° C., or about 40° C. and about 45° C., or about 45° C. and about 50° C., or about 50° C. and about 55° C., or about 55° C. and about 60° C., or about 60° C. and about 65° C., or about 65° C. and about 70° C., or about 70° C. and about 75° C., or about 75° C. and about 80° C., or about 85° C. and about 90° C., or about 95° C. and about 100° C., or about 100° C. and about 105° C., or about 105° C. and about 110° C., or about 110° C. and about 115° C., or about 115° C. and about 120° C., or about 120° C. and about 125° C., or about 125° C. and about 130° C., or about 130° C. and about 135° C., or about 135° C. and about 140° C., or about 140° C. and about 145° C., or about 145° C. and about 150° C., or about 150° C. and about 155° C., or about 155° C. and about 160° C., or about 160° C. and about 165° C., or about 165° C. and about 170° C., or about 170° C. and about 175° C., or about 175° C. and about 180° C., or about 180° C. and about 185° C., or about 185° C. and about 190° C., or about 190° C. and about 195° C., or about 195° C. and about 200° C., or about 200° C. and about 205° C., or about 205° C. and about 210° C., or about 210° C. and about 215° C., or about 215° C. and about 220° C., or about 220° C. and about 225° C., or about 225° C. and about 230° C., or about 230° C. and about 235° C., or about 235° C. and about 240° C., or about 240° C. and about 245° C., or about 245° C. and about 250° C.

As the person skilled in the art will appreciate, there may be many (co)polymers (comprising a single type of monomer or more than one type of monomer) which will have a T_{g} of between about −65° C. and about 250° C. Examples of polymers with a single type of monomer include polyacrylates and polymethacrylates. Examples of polymers with more than one type of monomer include, but are not limited to, those listed in Table 1. A person skilled in the art will readily be able to prepare polymers and determine their T_{g} to ensure that a suitable T_{g} is obtained.

### Polymer Particle Composition

In some embodiments, the polymer particles may comprise a homopolymer. For example, all the polymer particles may be comprised of polystyrene, or poly(n-butyl acrylate).

In other embodiments, the polymer particles may comprise a copolymer. For example, the polymer in the polymer particles may comprise two types of monomer, or three types of monomer, or more. Any of the monomers discussed above can be combined in any combination, to thereby tune the properties of the polymer-functional filler foam material. In some embodiments, styrene monomer is copolymerised with n-butyl acrylate to give polymer particles comprising polymers formed from two different monomers (copolymers).

In other embodiments, the foam material may comprise two or more different types of polymer particles. For example, the foam material may comprise polymer particles formed from one homopolymer, and polymer particles formed from a different homopolymer. In one particular embodiment, a foam material may comprise polymer particles formed from styrene, as well as polymer particles formed from n-butyl acrylate.

In some embodiments, the foam material comprises a combination of homopolymers and copolymers, which allows for tuning of the properties of the foam material.

### Particle Size

The size of the polymer particle is typically sub-micron in size, for example from about 10 nm to about 1000 nm. For example, the polymer particle may have a size of from about 10 nm to about 20 nm, or about 20 nm to about 30 nm, or about 30 nm to about 40 nm, or about 40 nm to about 50 nm, or about 50 nm to about 60 nm, or about 60 nm to about 70 nm, or about 70 nm to about 80 nm, or about 80 nm to about 90 nm, or about 90 nm to about 100 nm, or about 100 nm to about 150 nm, or about 150 nm to about 200 nm, or about 200 nm to about 250 nm, or about 250 nm to about 300 nm, or about 350 nm to about 400 nm, or about 400 nm to about 450 nm, or about 450 nm to about 500 nm, or about 500 nm to about 550 nm, or about 550 nm to about 600 nm, or about 600 nm to about 650 nm, or about 650 nm to about 700 nm, or about 700 nm to about 750 nm, or about 750 nm to about 800 nm, or about 800 nm to about 850 nm, or about 850 nm to about 900 nm, or about 900 nm to about 1000 nm. Other embodiments of the invention will comprise a polymer particle size of about 1000 nm to about 1050 nm, or about 1050 nm to about 1100 nm, or about 1100 nm to about 1150 nm, or about 1150 nm to about 1200 nm, or about 1200 nm to about 1250 nm, or about 1250 nm to about 1300 nm, or about 1300 nm to about 1350 nm, or about 1350 nm to about 1400 nm, or about 1400 nm to about 1450 nm, or about 1450 nm to about 1500 nm, or about 1500 nm to about 1550 nm, or about 1550 nm to about 1600 nm, or about 1600 nm to about 1650 nm, or about 1650 nm to about 1700 nm, or about 1700 nm to about 1750 nm, or about 1750 nm to about 1800 nm, or about 1800 nm to about 1850 nm, or about 1850 nm to about 1900 nm, or about 1900 nm to about 1950 nm, or about 1950 nm to about 2000 nm. In some embodiments, the size of the polymer particles is adjusted by the use of a surfactant, or by varying the amount or type of the surfactant, as will be known by the skilled person.

### Functional Fillers

Functional filler materials are particles added to polymer systems that can improve specific properties, make the product cheaper, or a mixture of both. The term “functional filler” is used herein synonymously with the term “filler”.

In some embodiments of the invention, the functional filler is glass or carbon fibers and/or any other mineral filler material such as talc or calcium carbonate. Examples of functional fillers are the following: natural calcium carbonates, including chalks, calcites and marbles; synthetic carbonates; magnesium and calcium salts; dolomites; magnesium carbonate; zinc carbonate; lime; magnesium minerals (hydroxide, carbonate); barium sulfate; baryta; calcium sulfate; silica; magnesium silicates; talcum powder; wollastonite; clays and aluminum silicates; kaolins; mica; oxide or hydroxides of metals or alkaline earths; magnesium hydroxide; iron oxides; zinc oxide; fiber or glass or carbon powder; wood powder or fiber or mixtures of these compounds.

Functional fillers can be generally divided into “0D” materials, e.g., quantum dots/nanoparticles, “1D” materials, e.g., rods, fibres, etc, and ‘2D” materials, e.g., sheets. Any functional filler falling within the scope of these definitions will be suitable for the method of the present invention, provided they may be disbursed in an aqueous phase, or treated such that they can be dispersed in an aqueous phase. In the following, several examples are provided relating to GO, rGO and GQDs as functional fillers. However, it will be appreciated that a wide variety of other functional fillers may be utilised in the invention. Other functional fillers include transition metal dichalcogenides, MXenes, and other similar layered materials.

### Types of GO

GO nanosheets are available in a number of different sizes and extents of oxidation, depending upon the conditions used to generate the GO. GO is typically provided as a solution in water, however, can also be provided as a dispersion, or even as a solid powder.

### Ratios of GO to Polymer

In some embodiments, the foam material has a weight ratio of polymer particles to GO in the range of from about 99:1 to about 90:10. For example, the weight ratio of polymer particles to graphene oxide is about 98:2, or about 97:3, or about 96:4, or about 95:5, or about 94:6, or about 93:7, or about 92:8, or about 91:9 or about 90:10. In some embodiments, the foam material has a weight ratio of polymer particles to GO in the range of 1-10 wt % GO relative to polymer. However, the method of the invention is not limited to this range.

In one aspect, the present invention provides a foam material produced from polymer particles and GO. The polymer particles may be coated with GO, which will result in the GO being relatively uniformly dispersed throughout the resulting foam material. In some embodiments, the foam material produced from the polymer particles and GO has an electrical conductivity of from about 10⁻¹⁵ S.m⁻¹ to about 10⁻⁵ S.m⁻¹. For example, the foam material comprising polymer particles and GO has an electrical conductivity of from about 10⁻¹⁵ S.m⁻¹ to about 10⁻¹⁴ S.m⁻¹, or from about 10⁻¹⁴ S.m⁻¹ to about 10⁻¹³ S.m⁻¹, or from about 10⁻¹³ S.m⁻¹ to about 10⁻¹² S.m⁻¹, or from about 10⁻¹² S.m⁻¹ to about 10; 11 S.m⁻¹, or from about 10⁻¹¹ S.m⁻¹ to about 10⁻¹⁰ S.m⁻¹, or from about 10⁻¹⁰ S.m⁻¹ to about 10.9 S.m⁻¹, or from about 10⁻⁹ S.m⁻¹ to about 10⁻⁸ S.m⁻¹, or from about 10⁻⁸ S.m⁻¹ to about 10⁻⁷ S.m⁻¹, or from about 10⁻⁷ S.m⁻¹ to about 10⁻⁶ S.m⁻¹, or from about 10⁻⁶ S.m⁻¹ to about 10⁻⁵ S.m⁻¹.

### Reduced GO

In some embodiments, GO may be converted to reduced GO (rGO). The GO may be reduced to rGO either before lyophilisation or after lyophilisation. Reduction may be effected by any number of methods known in the chemical arts, including but not limited to heating the GO, or exposing the GO to hydrazine vapour, urea, hydroiodic acid or other reducing agents, hydrogen plasma, strong pulses of light.

In some embodiments, rGO can be produced in the aqueous polymer/GO dispersion by in situ reduction using chemical reducing agents, including but not limited to hydrazine hydrate, hydroiodic acid, sodium borohydride and ascorbic acid, to form a colloidally stable aqueous dispersion of polymer particles and rGO.

In another aspect, the present invention provides a foam material produced from polymer particles and reduced GO (rGO). The polymer particles may be coated with rGO, resulting in the rGO being relatively uniformly dispersed throughout the foam material. In some embodiments, the foam material produced from polymer particles and rGO has an electrical conductivity of from about 1 S.m⁻¹ to about 10000 S.m⁻¹. For example, the foam material comprising polymer particles and rGO has an electrical conductivity of from about 1 S.m⁻¹ to about 1000 S.m⁻¹, or from about 1000 S.m⁻¹ to about 2000 S.m⁻¹, or from about 2000 S.m⁻¹ to about 3000 S.m⁻¹, or from about 3000 S.m⁻¹ to about 4000 S.m⁻¹, or from about 4000 S.m⁻¹ to about 5000 S.m⁻¹, or from about 5000 S.m⁻¹ to about 6000 S.m⁻¹, or from about 6000 S.m⁻¹ to about 7000 S.m⁻¹, or from about 7000 S.m⁻¹ to about 8000 S.m⁻¹, or from about 8000 S.m⁻¹ to about 9000 S.m⁻¹, or from about 9000 S.m⁻¹ to about 10000 S.m⁻¹. In some embodiments, the foam material produced from polymer particles and rGO has an electrical conductivity of from about 0.001 S.m⁻¹ to about 1 S.m⁻¹. For example, the foam material comprising polymer particles and rGO has an electrical conductivity of from about 0.001 S.m⁻¹ to about 0.01 S.m⁻¹, or from about 0.01 S.m⁻¹ to about 0.02 S.m⁻¹, or from about 0.02 S.m⁻¹ to about 0.03 S.m⁻¹, or from about 0.03 S.m⁻¹ to about 0.04 S.m⁻¹, or from about 0.04 S.m⁻¹ to about 0.05 S.m⁻¹, or from about 0.05 S.m⁻¹ to about 0.06 S.m⁻¹, or from about 0.06 S.m⁻¹ to about 0.07 S.m⁻¹, or from about 0.07 S.m⁻¹ to about 0.08 S.m⁻¹, or from about 0.08 S.m⁻¹ to about 0.09 S.m⁻¹, or from about 0.09 S.m⁻¹ to about 0.1 S.m⁻¹, or about 0.1 S.m⁻¹ to about 0.15 S.m⁻¹, or from about 0.15 S.m⁻¹ to about 0.2 S.m⁻¹, or from about 0.2 S.m⁻¹ to about 0.25 S.m⁻¹, or from about 0.25 S.m⁻¹ to about 0.3 S.m⁻¹, or from about 0.3 S.m⁻¹ to about 0.35 S.m⁻¹, or from about 0.35 S.m⁻¹ to about 0.4 S.m⁻¹, or from about 0.4 S.m⁻¹ to about 0.45 S.m⁻¹, or from about 0.45 S.m⁻¹ to about 0.5 S.m⁻¹, or about 0.5 S.m⁻¹ to about 0.55 S.m⁻¹, or from about 0.55 S.m⁻¹ to about 0.6 S.m⁻¹, or from about 0.6 S.m⁻¹ to about 0.65 S.m⁻¹, or from about 0.65 S.m⁻¹ to about 0.7 S.m⁻¹, or from about 0.7 S.m⁻¹ to about 0.75 S.m⁻¹, or from about 0.75 S.m⁻¹ to about 0.8 S.m⁻¹, or from about 0.8 S.m⁻¹ to about 0.85 S.m⁻¹, or from about 0.85 S.m⁻¹ to about 0.9 S.m⁻¹, or from about 0.9 S.m⁻¹ to about 0.95 S.m⁻¹, or from about 0.95 S.m⁻¹ to about 1 S.m⁻¹.

### Graphene Quantum Dots (GQDs)

In another aspect, the present invention provides a foam material produced from polymer particles and GQDs. GQDs may include nanographene molecules and graphene nanoribbons (GNRs). The polymer particles may be coated with GQDs, and the resulting foam has the GQDs relatively evenly dispersed throughout the foam material.

Combination of Polymer and GO (and/or rGO/GQDs)

Foam materials of the present invention may include one or more monomers/polymers and GO (or other functional fillers) as discussed below. Briefly, GO sheets (or other functional fillers) are introduced either by (i) miniemulsion polymerisation in the presence of GO to generate the aqueous dispersion of polymeric (nano)particles and

GO or (ii) mixing of an aqueous dispersion of polymeric (nano)particles and an aqueous dispersion of GO.

### Miniemulsion Polymerisation

One strategy is to form a dispersion of polymer particles in an aqueous phase, wherein the polymer particles comprise a homopolymer coated with GO is summarised in FIG. 2. A monomer is emulsified in the presence of GO to form GO-functionalised monomer droplets. The GO-functionalised (stabilised) monomer droplets are then polymerised to form coated polymer particles, wherein the polymer particles comprise a homopolymer. If the monomer is not a liquid at room temperature but a solid, it can be dissolved in a suitable solvent that is immiscible with water. After subsequent polymerization, the solvent would be evaporated to yield polymer particles coated with GO as above.

### Blend-Miniemulsion

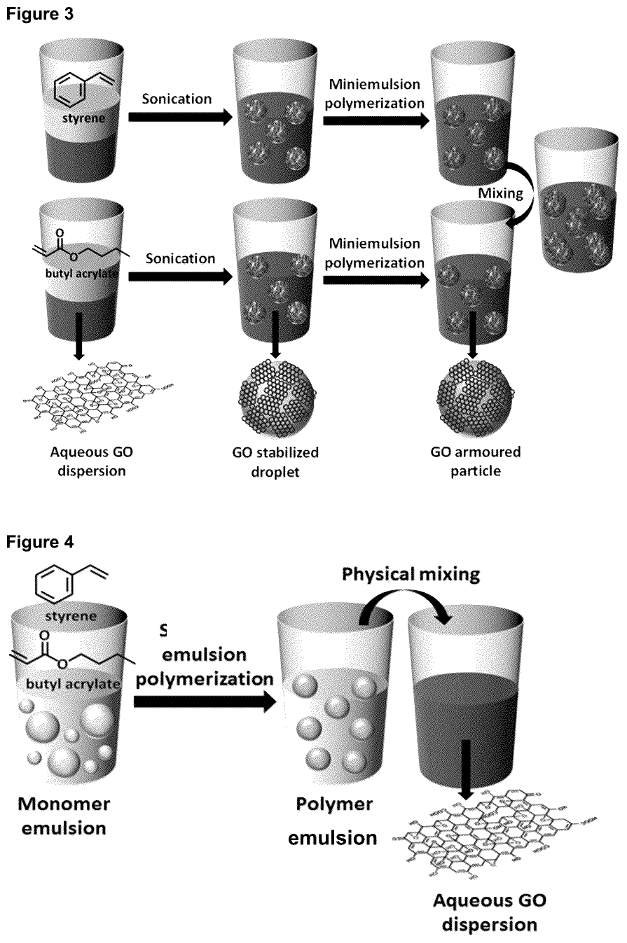

One strategy to form a dispersion which comprises two or more different types of polymer particles is summarised in FIG. 3. In this example, two different monomers (e.g. styrene and n-butyl acrylate) are separately emulsified in the presence of GO to form two separate GO-stabilised monomer droplet compositions. The GO-stabilised monomer droplet compositions are then separately polymerised to form GO-coated polymer particles, wherein the polymer particles each comprise a homopolymer. The different coated polymer particles are then mixed to form two different GO-coated polymer particles.

### Physical Mixing

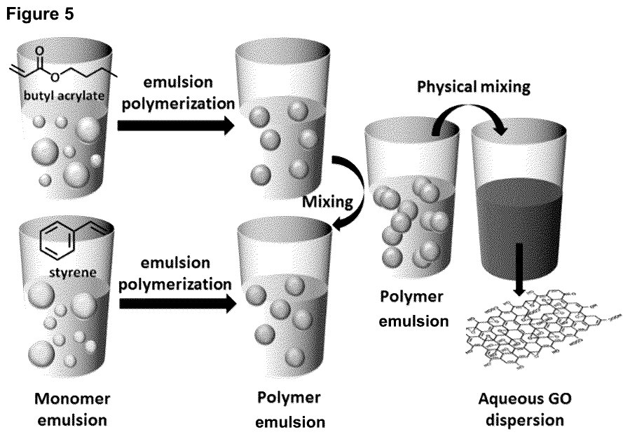

One strategy to form a dispersion wherein the coated polymer particle, or mixture of polymer particles and aqueous GO, comprises a copolymer is summarised in FIG. 4. In this example, two different monomers (e.g. styrene and n-butyl acrylate) are mixed together, emulsified, and copolymerised to form a dispersion of polymer particles comprising the two co-monomers. The resulting polymer particles are mixed with GO to form the polymer particle/GO mixture, wherein the polymer particle comprises a copolymer formed from two types of monomer.

### Blend-Physical Mixing

Another strategy to form a dispersion which comprises two or more different polymer particles is summarised in FIG. 5. In this example, two different monomers (e.g. n-butyl acrylate and styrene) are separately emulsified and polymerised to form a dispersion of polymer particles, each comprising a homopolymer. The two different types of polymer particle are then mixed, in the presence of GO.

### Surfactant

In some embodiments, a surfactant may be added to assist in the emulsification or dispersion process. The invention is not limited to the use of a surfactant, or a particular type of surfactant, or at what step the surfactant is used, or how much is to be used. Any surfactant that supports the emulsion/miniemulsion formation can be used. Examples of suitable surfactants include, but are not limited to, ammonium lauryl sulfate (ALS), sodium dodecylbenzenesulfonate (SDBS), sodium dodecyl sulfate (SDS), sodium laureth sulfate (SLES), sodium lauroyl sarcosinate (sarkosyl), sodium myreth sulfate, sodium pareth sulfate, behentrimonium chloride (docosyltrimethylammonium chloride, BTAC-228) cetrimonium bromide (CTAB), and cetrimonium chloride. In certain embodiments, the surfactant is sodium dodecyl sulfate (SDS).

The surfactant, if present, is typically provided in an amount ranging from about 0.5 wt % to about 5 wt %, compared to the weight of the monomer. For example, the surfactant is provided in an amount of from about 0.5 wt % to about 1 wt %, or about 1 wt % to about 1.5 wt %, or about 1.5 wt % to about 2 wt %, or about 2.5 wt % to about 3 wt %, or about 3 wt % to about 3.5 wt %, or about 3.5 wt % to about 4 wt %, or about 4 wt % to about 4.5 wt %, or about 4.5 wt % to about 5 wt %, compared to the weight of the monomer. In certain embodiments, no surfactant is used. In other embodiments, the surfactant is provided in an amount of about 1 wt %, compared to the weight of the monomer.

If a surfactant is used, the surfactant may be added at any number of steps throughout the foam forming procedure. For example, the surfactant may be added to one or more of:
the emulsion comprising monomer droplets in an aqueous continuous phase;
the emulsion comprising GO-stabilised monomer droplets in an aqueous continuous phase;
the dispersion comprising polymer particles;
the aqueous dispersion of GO; or
the dispersion comprising polymer particles and GO.

The mixture of surfactant and other components will then need to be thoroughly mixed, such as by physical mixing or as part of the emulsification process.

### Other Additives

Other additives may be used in the present invention. One such example is hexadecane, which is used to stabilize monomer droplets in a miniemulsion.

### Method of Forming a Foam Material

The foam material may be formed by providing (i) an aqueous dispersion comprising a polymer particle, which are preferably coated with GO or (ii) an aqueous dispersion of polymer particles mixed with GO, freezing the dispersion, and then undertaking a lyophilising process on the frozen dispersion to form the foam material.

Typically, freezing is carried out in a conventional freezer, with cooling to −20° C. However, liquid nitrogen could also be used. The present inventors have also surprisingly found that it is additionally possible to tune the properties of the resulting nanocomposite foam by selecting the direction of freezing, which can affect the distribution of functional filler throughout the foam.

Lyophilisation (or “freeze drying”) is a process whereby a material is frozen in a solvent (typically water), and then the frozen solvent is removed via sublimation at low pressure (high vacuum). The time taken to remove the solvent will vary depending upon the vacuum used, the amount of water present, and how strongly the water is held by the mixture. In some embodiments, the lyophilisation is carried out for 24 hours.

The amount of water used in the formulation may vary. For example, if too much water is used, there may be insufficient coated polymer particles to form a stable porous material such as a foam, and if insufficient water is used then the foam may be too dense for its intended purpose. The skilled person will be able to readily discern the amount of water used in the aqueous phase, prior to lyophilisation. For example, the amount of water used to form an emulsion or dispersion may be in the range of from about 10 mL to about 20 mL per gram of monomer, such as about 11 mL per gram of monomer, or about 12 mL per gram of monomer, or about 13 mL per gram of monomer, or about 14 mL per gram of monomer, or about 15 mL per gram of monomer, or about 16 mL per gram of monomer, or about 17 mL per gram of monomer, or about 18 mL per gram of monomer, or about 19 mL per gram of monomer. In some embodiments, the amount of water used to form an emulsion or dispersion is about 14 mL per gram of monomer. In some embodiments, the amount of water per gram of monomer in the emulsion or dispersion is 5, 6, 7, 8, 9, 10, 11, 12, 13, 14, 15, 16, 17, 18, 19, 20, 21, 22, 23, 24, or 25 mL.

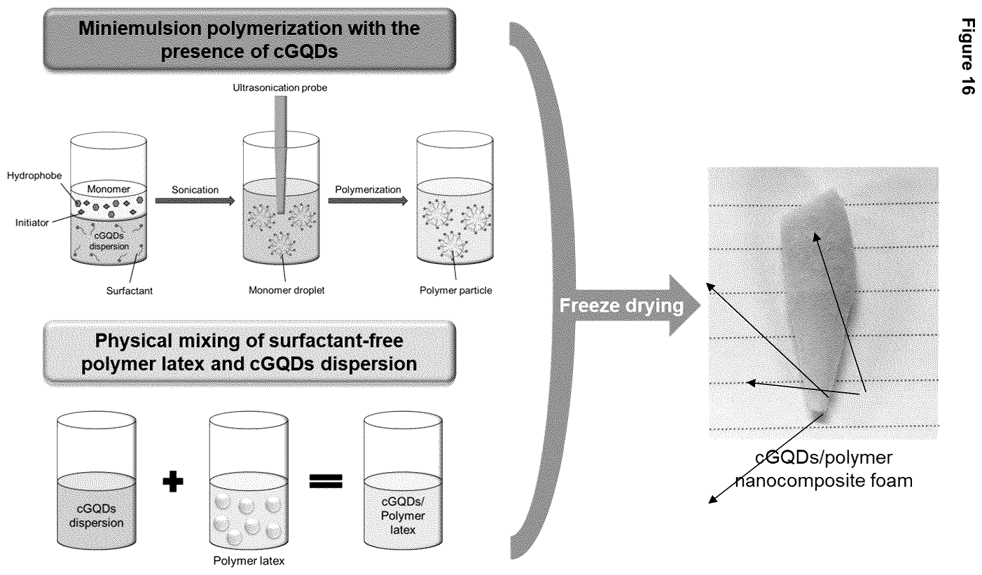

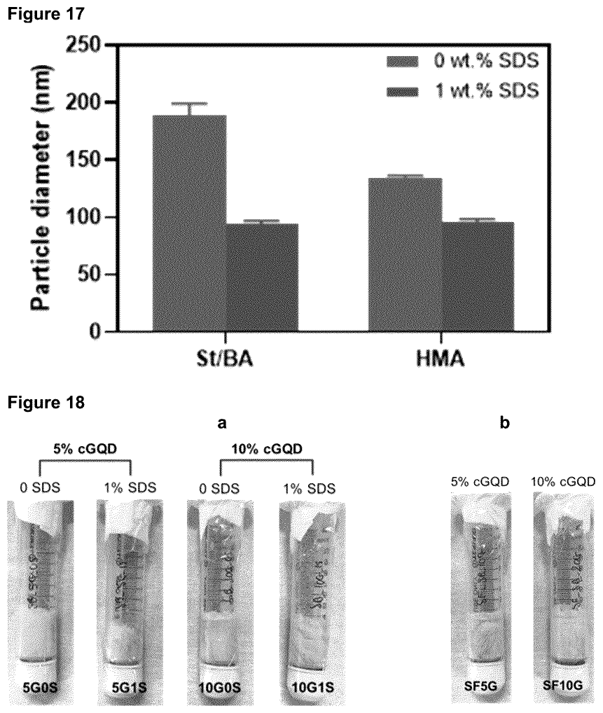

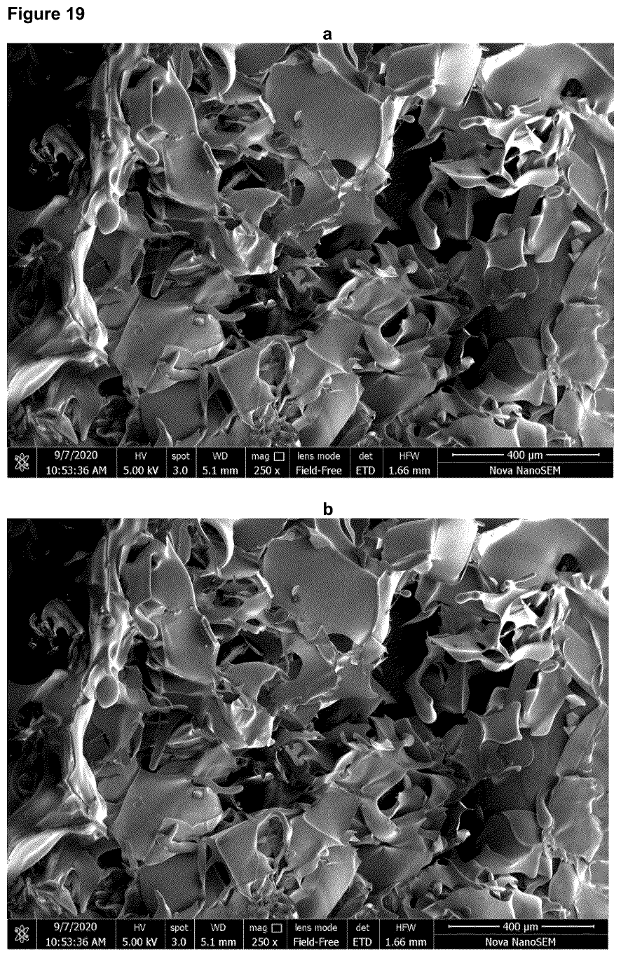

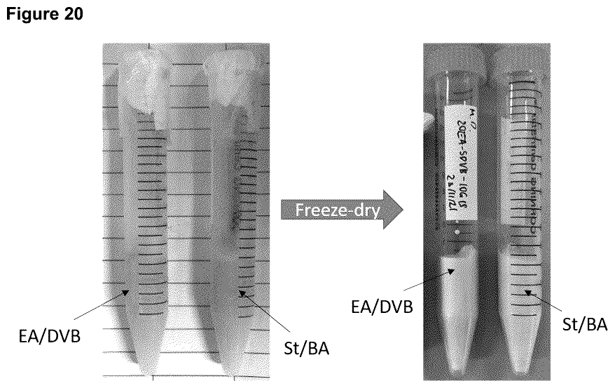

The skilled person will appreciate that the embodiments described herein also apply to the combination of polymer and GO and/or rGO and/or GQDs as well as other filler materials. For example, FIG. 16 shows polymer/cGQDs foam formation from miniemulsion polymerisation and physical mixing.

### Tuning the Foam Material

The mechanical properties and porosity of the foams of the invention can be tuned, for example, by either altering the polymer type, polymer amount, extent of crosslinking, amount of functional filler, its composition, and any combinations thereof.

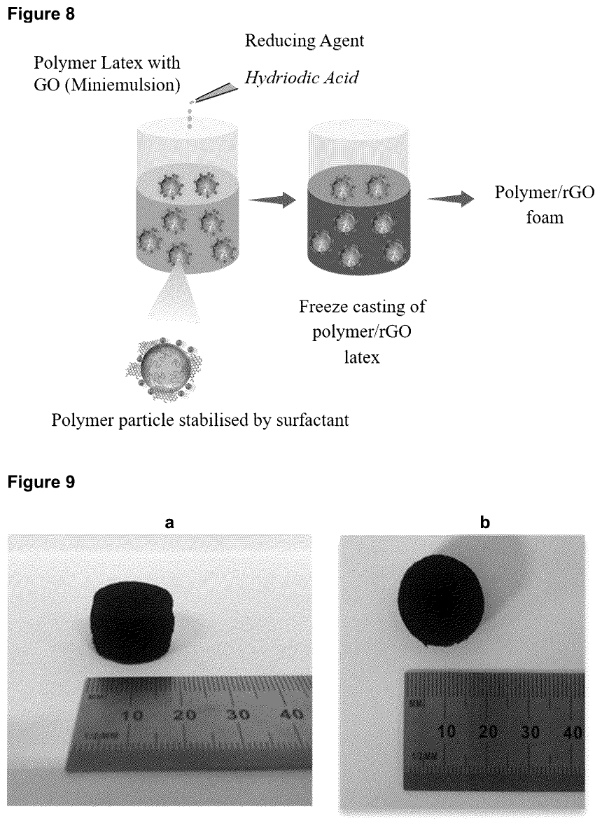

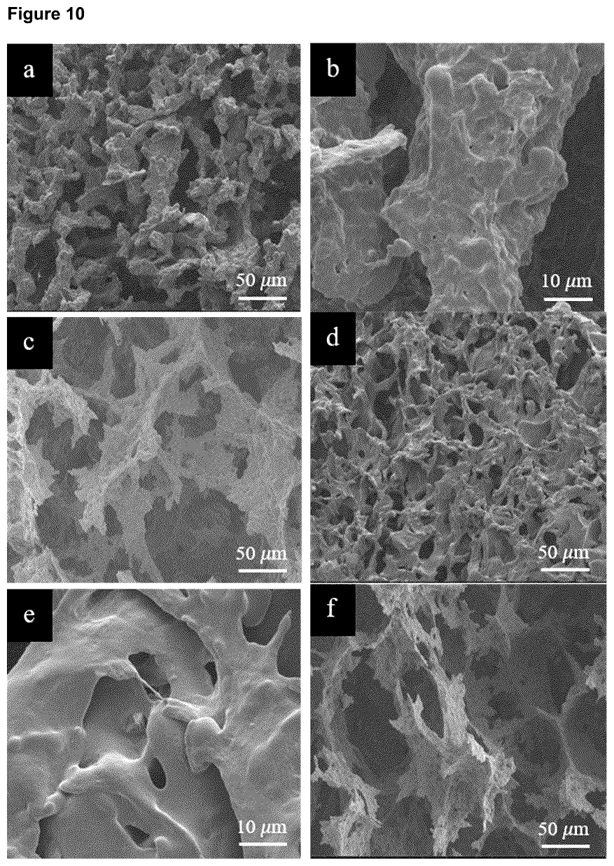

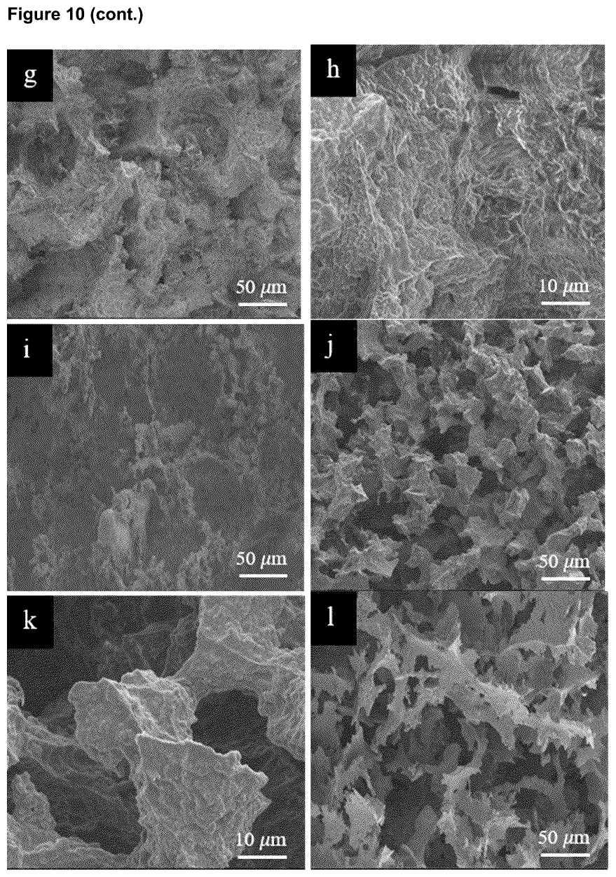

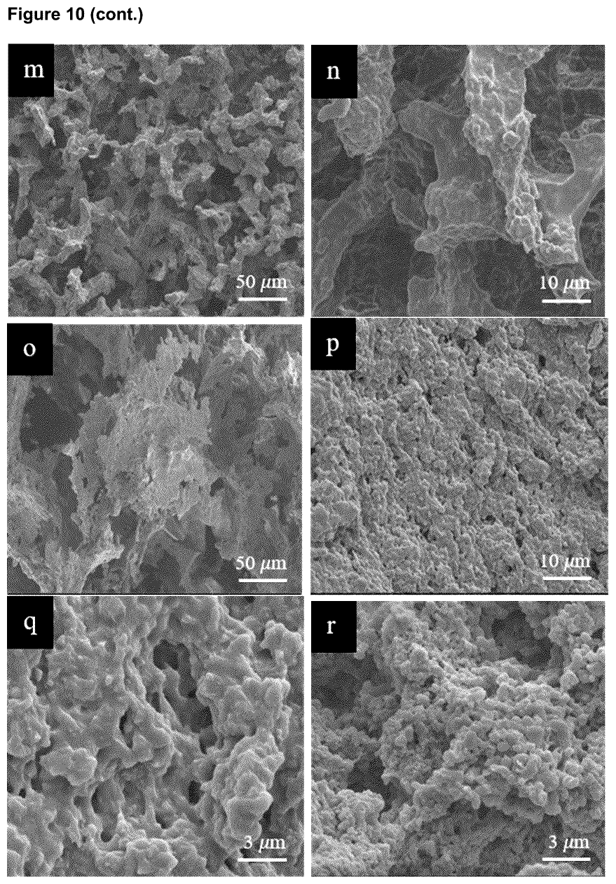

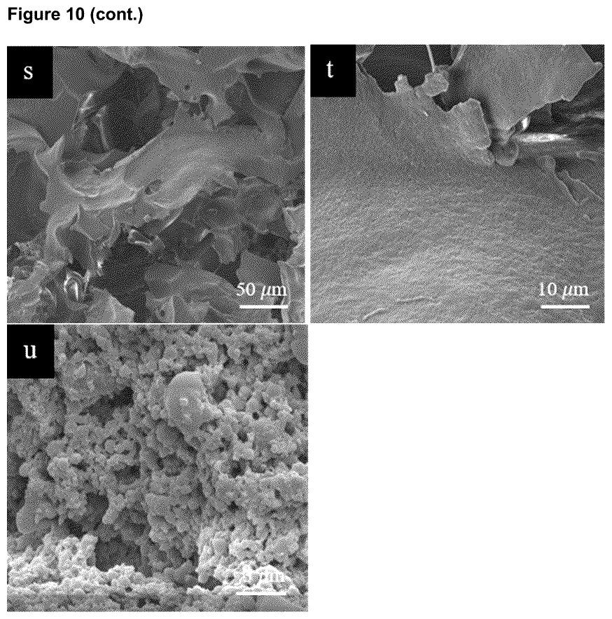

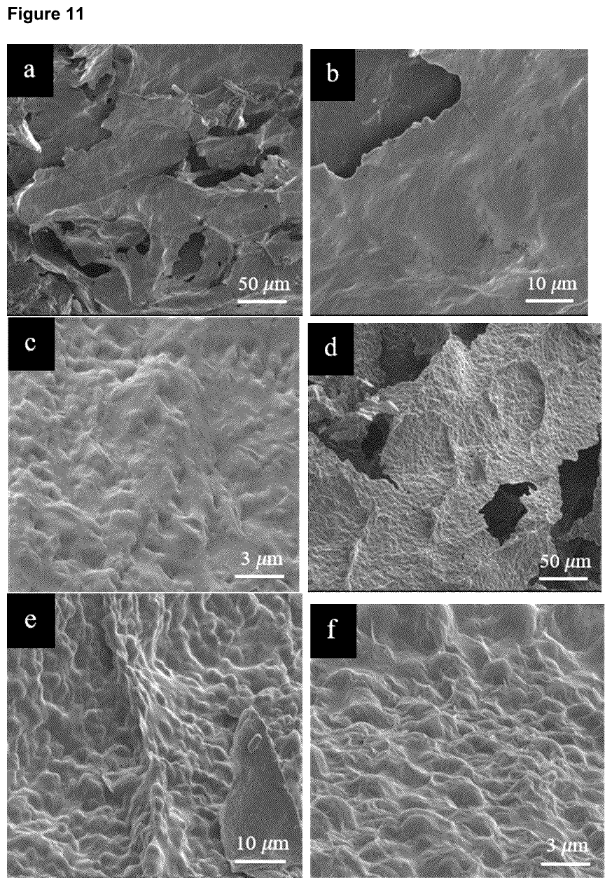

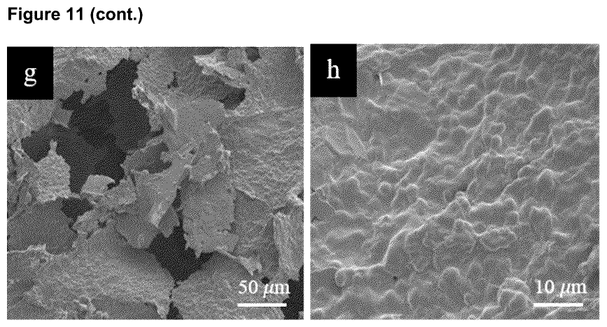

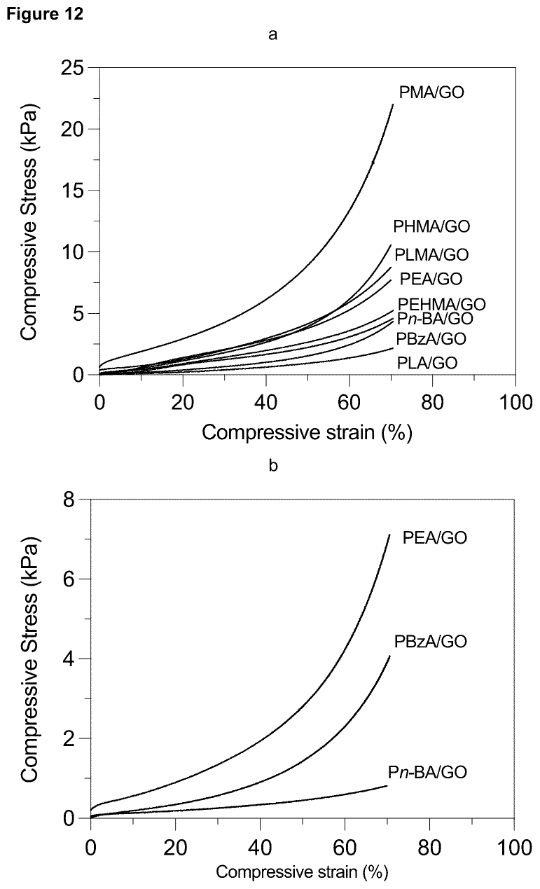

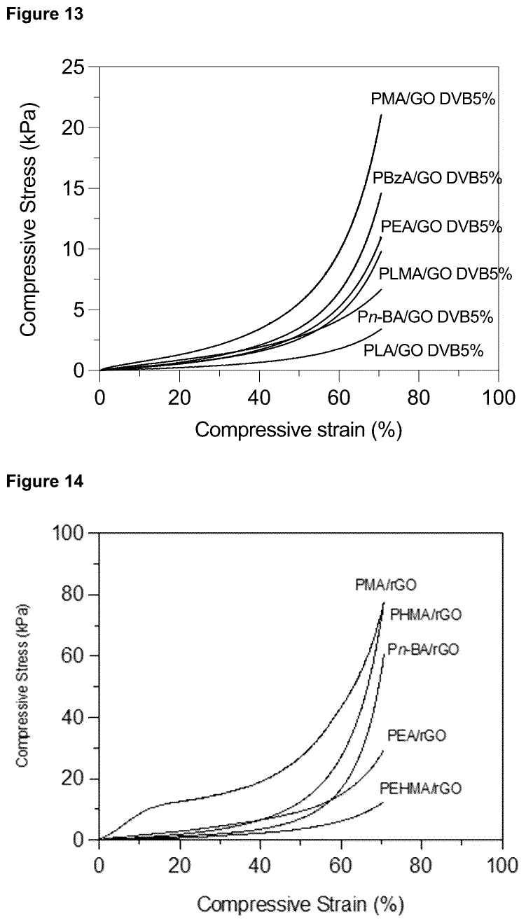

Physicochemical, mechanical, thermal and/or electrical properties of the filled polymer foams can be further tuned by different means such as:
1) in situ crosslinking of the polymer matrix during the polymerisation process using crosslinkers such as divinylbenzene (DVB), ethylene glycol dimethacrylate (EGDMA) and tetra(ethylene glycol) diacrylate (TEGDA),
2) post polymerisation crosslinking of the polymer,
3) crosslinking or surface functionalization of the functional filler (e.g., GO) post polymerisation,
4) crosslinking between polymer and functional filler (e.g., GO) post polymerisation,
5) reduction of GO either prior to or after the polymerisation before the fabrication of the foam, as shown in FIG. 8.
6) varying the polymer particle size by altering the amount of surfactant, monomer and/or the intensity of high-shear forces when creating miniemulsion, or other means,
7) varying the amount of functional filler, and/or
8) varying the size of the functional filler (e.g., the GO sheets).

Emulsions/miniemulsions comprising monomer and water can be formed by any number of methods which are known in the art. For example, the emulsifying step may be carried out by mixing, shaking, stirring, via homogenisation, or by ultrasonification. In preferred embodiments, the emulsifying step is carried out by ultrasonification.

In some embodiments, the foam material may be tuned by in situ cross-linking of the polymer matrix during the polymerisation process. This may be done by use of cross-linkers such as divinylbenzene. Alternatively, the polymer may be cross-linked post-polymerisation. In some embodiments, the crosslinker is typically provided in an amount ranging from about 0.5 wt % to about 20 wt %, compared to the weight of the monomer. For example, the crosslinker is provided in an amount of from about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1 wt %, or about 1 wt % to about 1.5 wt %, or about 1.5 wt % to about 2 wt %, or about 2 wt % to about 2.5 wt %, or about 2.5 wt % to about 3 wt %, or about 3 wt % to about 3.5 wt %, or about 3.5 wt % to about 4 wt %, or about 4 wt % to about 4.5 wt %, or about 4.5 wt % to about 5 wt %, or about 5 wt % to about 5.5 wt %, or about 5.5 wt % to about 6 wt %, or about 6 wt % to about 6.5 wt %, or about 6.5 wt % to about 7 wt %, or about 7 wt % to about 7.5 wt %, or about 7.5 wt % to about 8 wt %, or about 8 wt % to about 8.5 wt %, or about 8.5 wt % to about 9 wt %, or about 9 wt % to about 9.5 wt %, or about 9.5 wt % to about 10 wt %, or about 10 wt % to about 10.5 wt %, or about 10.5 wt % to about 11 wt %, or about 11 wt % to about 11.5 wt %, or about 11.5 wt % to about 12 wt %, or about 12 wt % to about 12.5 wt %, or about 12.5 wt % to about 13 wt %, or about 13 wt % to about 13.5 wt %, or about 13.5 wt % to about 14 wt %, or about 14 wt % to about 14.5 wt %, or about 14.5 wt % to about 15 wt %, or about 15 wt % to about 15.5 wt %, or about 15.5 wt % to about 16 wt %, or about 16 wt % to about 16.5 wt %, or about 16.5 wt % to about 17 wt %, or about 17 wt % to about 17.5 wt %, or about 17.5 wt % to about 18 wt %, or about 18 wt % to about 18.5 wt %, or about 18.5 wt % to about 19 wt %, or about 19 wt % to about 19.5 wt %, or about 19.5 wt % to about 20 wt %. In some embodiments, the crosslinker is provided in an amount of about 5 wt %, compared to the weight of the monomer.

In some embodiments, the mechanical properties can be adjusted by adjusting the relative amount of different functional fillers, such as GO vs rGO. For example, for the present invention, an increase in the mechanical properties (Compressive Strength and Young's Modulus) of the foam was observed, by reducing the GO to reduced GO (rGO) in the same foam, for example by chemically reducing the GO, as shown in Table 3. Increases in compressive strength of 2, 3, 4, 5, 6, 7, 8, 9, 10, 11, 12, 13, 14, 15 times has been observed. Increases in Young's Modulus of 2, 3, 4, 5, 6, 7, 8, 9, 10, 15, 20, 25, 30, 35, 40, 45, 50, 55, 60, 65, 70 times have been observed. Without wishing to be bound by theory, the present inventors contemplate that the marked improvement in mechanical properties may be attributed to the combination of (i) superior intrinsic stiffness and toughness of rGO sheets (due to the restoration of sp2 hybridised carbon cluster) compared to GO sheets i.e., sp2 hybridised carbon basal plane is considered the reason behind exquisite strength of graphene sheets, and (ii) shrinkage (of around 5 to 15%) in reduced foams (after freeze-drying)—shrinkage increases the density of the foam which may result in thicker wall networks within the reduced nanocomposite foam.

In some embodiments, the amount of crosslinker used during the polymerisation process can be tuned to obtain foam materials with different mechanical properties. For example, for the present invention, an increase in the mechanical properties of the foam was observed, by crosslinking PLMA, as shown in Table 1 and Table 2. Increases in compressive strength of 2, 3, 4, 5, 6, 7, 8, 9, 10, 11, 12, 13, 14, 15 times has been observed. Increases in Young's Modulus of 2, 3, 4, 5, 6, 7, 8, 9, 10, 11, 12, 13, 14, 15 times has been observed.

In some embodiments, the foam material may be compressed to reduce the initial volume to a predetermined final volume to tune its electrical conductivity. For example, it has been found that the electrical conductivity of PEA/rGO is increased after compression, and the electrical conductivity of PEHMA/rGO is decreased after compression. Without wishing to be bound by theory, the present inventors contemplate that these effects could be due to the arrangement of rGO sheets within the foam and difference in inter-rGO sheet networks within foams.

In some embodiments, the foam material may be tuned to have a compressive strength within the range from about 0.5 kPa to about 150 kPa. For example, the compressive strength is from about 0.5 kPa to about 1 kPa, or about 1 kPa to about 10 kPa, or about 10 kPa to about 20 kPa, or about 20 kPa to about 30 kPa, or about 30 kPa to about 40 kPa, or about 40 kPa to about 50 kPa, about 50 kPa to about 60 kPa, or about 60 kPa to about 70 kPa, or about 70 kPa to about 80 kPa, about 80 kPa to about 90 kPa, or about 90 kPa to about 100 kPa, or about 100 kPa to about 110 kPa, or about 110 kPa to about 120 kPa, about 120 kPa to about 130 kPa, or about 130 kPa to about 140 kPa, or about 140 kPa to about 150 kPa.

In some embodiments, the foam material may be tuned to have a Young's modulus falling within the range from about 1 kPa to about 5000 kPa. For example, the Young's modulus is from about 1 kPa to about 100 kPa, or about 100 kPa to about 200 kPa, or about 200 kPa to about 300 kPa, or about 300 kPa to about 400 kPa, or about 400 kPa to about 500 kPa, or about 500 kPa to about 600 kPa, or about 600 kPa to about 700 kPa, or about 700 kPa to about 800 kPa, or about 800 kPa to about 900 kPa, or about 900 kPa to about 1000 kPa, or about 1000 kPa to 1100 kPa, or about 1100 kPa to about 1200 kPa, or about 1200 kPa to about 1300 kPa, or about 1300 kPa to about 1400 kPa, or about 1400 kPa to about 1500 kPa, or about 1500 kPa to about 1600 kPa, or about 1600 kPa to about 1700 kPa, or about 1700 kPa to about 1800 kPa, or about 1800 kPa to about 1900 kPa, or about 1900 kPa to about 2000 kPa, or about 2000 kPa to 2100 kPa, or about 2100 kPa to about 2200 kPa, or about 2200 kPa to about 2300 kPa, or about 2300 kPa to about 2400 kPa, or about 2400 kPa to about 2500 kPa, or about 2500 kPa to about 2600 kPa, or about 2600 kPa to about 2700 kPa, or about 2700 kPa to about 2800 kPa, or about 2800 kPa to about 2900 kPa, or about 2900 kPa to about 3000 kPa, or about 3000 kPa to 3100 kPa, or about 3100 kPa to about 3200 kPa, or about 3200 kPa to about 3300 kPa, or about 3300 kPa to about 3400 kPa, or about 3400 kPa to about 3500 kPa, or about 3500 kPa to about 3600 kPa, or about 3600 kPa to about 3700 kPa, or about 3700 kPa to about 3800 kPa, or about 3800 kPa to about 3900 kPa, or about 3900 kPa to about 4000 kPa, or about 4000 kPa to 4100 kPa, or about 4100 kPa to about 4200 kPa, or about 4200 kPa to about 4300 kPa, or about 4300 kPa to about 4400 kPa, or about 4400 kPa to about 4500 kPa, or about 4500 kPa to about 4600 kPa, or about 4600 kPa to about 4700 kPa, or about 4700 kPa to about 4800 kPa, or about 4800 kPa to about 4900 kPa, or about 4900 kPa to about 5000 kPa.

Other ways to tune the foam material of the invention may be to cross-link or surface functionalize the GO post polymerisation. The functional groups present in GO are typically hydroxy, carbonyl, epoxy, or carboxylic acid. The skilled person will appreciate that there are well known chemicals that will react with these functional groups present in GO to obtain cross-linking or surface functionalisation. For example, hydroxy groups may react with an electrophilic moiety or any moiety that has a leaving group, such as alkyl halides, mesylates, tosylates, and epoxides. Carbonyl groups and epoxy groups may react with a nucleophilic moiety such as amines, hydroxy groups, halides, and thiols. Carboxylic acids may react with bases, nucleophilic moiety or metal salts, or they may be decarboxylated, reduced or esterified, in order to tune the properties of the GO.

Applications The foam materials of the present invention can be used for any number of purposes, including but not limited to: anti-static casings, electrode materials, support elements, insulators, in catalysis, as membranes for water filtration, heat transfer materials, sound absorbing materials, implantable materials for biomedical engineering, electromagnetic shielding such as for defence or in the aviation industry. An anti-static casing is a casing that reduces or eliminates build up of static electricity, due to its electrical conductivity. If the polymer/GO foam material is incorporated into an electrode material, such materials would benefit from the light weight of the foam and the electrical conductivity imparted by the GO. In other uses, it may be beneficial to incorporate GO (and/or rGO/GQDs) into a polymer such as a membrane for water filtration, for example, if it is desired to run an electric current through the membrane or change the surface properties of the membrane. Electrically conductive membranes may be able to facilitate electrolysis of any material that may be prevented from passing through the membrane. Surface functionalised fillers can trap anionic and cationic ion (e.g. metal ions) species depending on the surface properties of the filler used in these foams. In addition, oxygen-containing functional groups in GO may also induce more frictional resistance to the water molecules during the filtration process. As such, the material can be tuned to include rGO and/or GQDs, to affect the filtration properties of such a material. The skilled person will be able to tune the polymer and the GO (and/or rGO/GQDs) appropriately, as described above, to achieve the desired properties such as size of the pores, surface properties, and conductivity of the foam material.

### EXAMPLES

The present invention will now be described with reference to the following examples which should be considered in all respects as illustrative and non-restrictive.

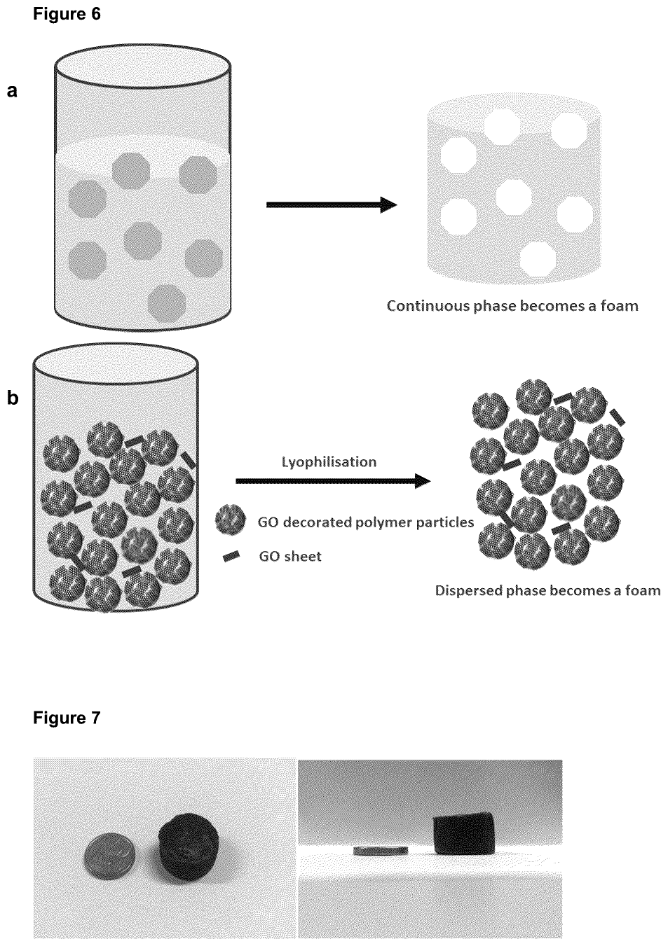

The foam fabrication process entails two basic steps: (i) preparation of an aqueous dispersion comprising polymer and functional filler, and (ii) subjecting the dispersion to freeze-drying to remove water and form the foam, as illustrated by FIG. 6b.

Whilst the examples discussed below utilise GO/rGO as a functional filler, it will be appreciated that other functional fillers could be used instead of, or in addition to GO/rGO. The present invention should not be limited to nanocomposite foam materials that utilise GO/rGO as functional filler.

### Example 1

A typical miniemulsion is prepared by first mixing the organic phase with an aqueous dispersion of GO. The organic phase is prepared with 1.050 g of monomer, 0.011 g of sodium dodecyl sulfate (SDS), 0.053 g of the hydrophobe hexadecane (HD), and 0.045 g of azo initiator azobisisobutyronitrile (AIBN). The aqueous phase comprises 13.125 g dispersed GO nanosheets (4 mg/mL) topped up with water to a total of 15 g to create a 5 wt % GO nanosheet dispersion in water. The organic and aqueous phases are subsequently mixed and subjected to high shear forces via ultrasonification in an ice bath for 10 min to form a miniemulsion. The miniemulsion is purged with nitrogen gas for 20 min to remove oxygen and is subsequently heated at 70° C. for 24 h in an oil bath to convert monomer to polymer via radical polymerization.

### Example 2

In this case, a polymer dispersion is first prepared via surfactant-free emulsion polymerization using 1.050 g of monomer, 0.05 g of potassium persulfate, and water. The resulting polymer dispersion is then mixed with an aqueous dispersion of GO.

### Example 3

The polymer/GO dispersions obtained from Examples 1 or 2 are subsequently frozen in a conventional freezer (−20° C.). The frozen dispersion is lyophilised using a traditional freeze dryer for 24 h to obtain the foam.

### Example 4

The freeze-dried polymer/GO foam is chemically reduced (i.e. converting GO to “reduced GO” (rGO)) using hydrazine vapour at 90° C. for 24 h followed by vacuum drying overnight.

### Example 5

With reference to FIG. 15, polystyrene (1 g) was dissolved in 15 mL of chloroform (organic phase). To this organic phase, aqueous dispersion of GO (5 wt % relative to polymer) and surfactant (SDS, 1 wt % relative to organic phase) was added, and mixed. The obtained dispersion was frozen and freeze dried to obtain the foam.

### Analytical Data of Polymer/GO and Polymer/rGO Foams

The following tables list exemplary polymer/GO and polymer/rGO foam materials prepared in accordance with the methods as discussed herein, along with their mechanical properties:

TABLE 1
Mechanical properties and glass transition temperature (Tg) for polymer/GO
foams obtained from miniemulsion polymerization and physical mixing

| Polymer/ | | Compressive | Young's | |
|---|---|---|---|---|
| GO | T_{g} | strength | Modulus | |
| Foam | (° C.) | (kPa) | (kPa) | Chemical Structure of Polymer |
| poly(lauryl methacrylate) (PLMA)/GO | −65 | 1.7 (miniemulsion polymerisation) | 8.9 (miniemulsion polymerisation) | 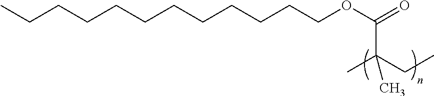 |
| poly(n-butyl acrylate) (Pn-BA)/GO | −54 | 4.0 (miniemulsion polymerisation) 0.8 (physical mixing) | 21.4 (miniemulsion polymerisation) 2.4 (physical mixing) | 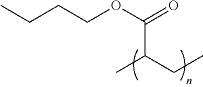 |
| poly(ethyl acrylate) (PEA)/GO | −24 | 8.6 (miniemulsion polymerisation) 7.1 (physical mixing) | 50.7 (miniemulsion polymerisation) 34.8 (physical mixing) | 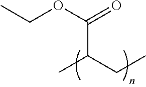 |
| poly(lauryl acrylate) (PLA)/GO | −19 | 1.6 (miniemulsion polymerisation) | 12.5 (miniemulsion polymerisation) | 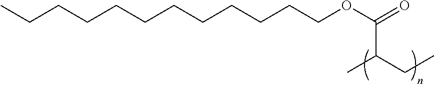 |
| poly(2- ethylhexyl methacrylate) (PEHMA)/GO | −10 | 5.4 (miniemulsion polymerisation) | 35.3 (miniemulsion polymerisation) | 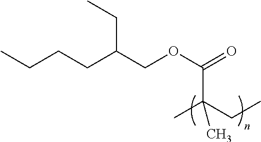 |
| poly(hexyl methacrylate) (PHMA)/GO | −5 | 6.9 (miniemulsion polymerisation) | 40.1 (miniemulsion polymerisation) | 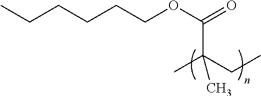 |
| poly(styrene- stat-n-butyl acrylate) (P(S-stat- nBA))/GO | 3 | 11.43 (miniemulsion polymerisation) | 128.03 (miniemulsion polymerisation) | 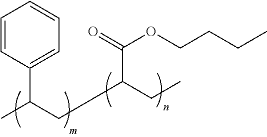 |
| poly(benzyl acrylate) (PBzA)/GO | 6 | 8.0 (miniemulsion polymerisation) 4.0 (physical mixing) | 72.5 (miniemulsion polymerisation) 21.4 (physical mixing) | 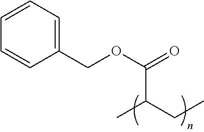 |
| poly(methyl acrylate) (PMA)/GO | 10 | 17.5 (miniemulsion polymerisation) | 185.6 (miniemulsion polymerisation) | 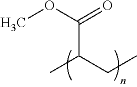 |

TABLE 2
Mechanical properties and glass transition temperature
(T_{g}) for crosslinked polymer/GO foams obtained
from miniemulsion polymerization

| | | Compressive | Young's |
|---|---|---|---|
| | T_{g} | strength | Modulus |
| Polymer/GO Foam | (° C.) | (kPa) | (kPa) |
| PLMA/DVB/GO | −65 | 9.8 | 110.0 |
| Pn-BA/DVB/GO | −54 | 6.7 | 38.2 |
| PEA/DVB/GO | −24 | 11.0 | 118.5 |
| PLA/DVB/GO | −19 | 3.4 | 29.7 |
| PEHMA/DVB/GO | −10 | Brittle | Brittle |
| PHMA/DVB/GO | −5 | Brittle | Brittle |
| PBzA/DVB/GO | 6 | 14.6 | 181.8 |
| PMA/DVB/GO | 10 | 21.1 | 241.0 |

TABLE 3
Mechanical properties and glass transition temperature
(T_{g}) for various polymer/GO and polymer/rGO foams

| | | Compressive | Young's | Compressive | Young's |
|---|---|---|---|---|---|
| | | strength | Modulus | strength | Modulus |
| | T_{g} | (kPa) | (kPa) | (kPa) | (kPa) |
| Polymer | (° C.) | Polymer/GO | | Polymer/rGO | |
| Pn-BA | −54 | 4.0 | 21.4 | 60.1 | 2187.3 |
| PEA | −24 | 8.6 | 50.7 | 29.1 | 332.7 |
| PEHMA | −10 | 5.4 | 35.3 | 12.6 | 141.0 |
| PHMA | −5 | 6.9 | 40.1 | 77.4 | 2604.3 |
| PMA | 10 | 17.5 | 185.6 | 77.2 | 750.4 |

TABLE 4
Conductivity comparison of polymer/rGO
foams: uncompressed and compressed

Electrical Conductivity (S/m)

| | Uncompressed | |
|---|---|---|
| Polymer/rGO Foam | (as synthesised) | Compressed |
| Pn-BA/rGO | 0.034 | 0.079 |
| PEA/rGO | 0.003 | 0.019 |
| PEHMA/rGO | 0.131 | 0.091 |
| PHMA/rGO | 0.055 | 0.100 |
| PMA/rGO | 0.008 | 0.003 |

Although the invention has been described with reference to specific examples, it will be appreciated by those skilled in the art that the invention may be embodied in many other forms in particular features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of forming a foam material, the method comprising the steps of:
a) providing an aqueous dispersion comprising polymer particles and a functional filler dispersed in the aqueous phase, and
b) lyophilising the aqueous dispersion, to thereby form the foam material.

2. The method according to claim 1, wherein the polymer particles in step (a) are produced by:
(i) providing a monomer;
(ii) emulsifying the monomer to provide an emulsion comprising stabilised monomer droplets in an aqueous phase; and
(iii) polymerising the monomer to form said polymer particles.

3. The method of claim 1, wherein step (a) is provided by:
(i) dissolving a polymer in a solvent to form a first solution;
(ii) combining the first solution with the functional filler dispersed in the aqueous phase; and
(iii) forming an aqueous dispersion of said polymer, preferably by sonication, to produced said polymer particles.

4. The method according to claim 2 or claim 3, further comprising a step of adding a surfactant, preferably sodium dodecyl sulfate.

5. The method of any one of claims 1 to 4, wherein said functional filler is selected from the group consisting of graphene oxide (GO), reduced graphene oxide (rGO), graphene quantum dots (GQDs), carbon nanotubes (CNTs), carbon black, carbon dots, gold or silver nanoparticles, polymer fibres or combinations thereof.

6. The method according to claim 5, further comprising a step of at least partially reducing the GO to form rGO prior to step (b), preferably the GO is chemically reduced to form rGO.

7. The method according to claim 5, further comprising a step of at least partially reducing the GO to form rGO after step (b).

8. The method according to any one of claims 1 to 7, wherein the polymer particles are comprised of a homopolymer, a copolymer, or a combination thereof, and are optionally crosslinked.

9. The method according to any one of claims 1 to 8, wherein the polymer particles have a glass transition temperature (T_{g}) in the range of about −65° C. to about 250° C.

10. The method according to any one of claims 1 to 9 wherein the polymer particles are comprised of polymers selected from polystyrene, poly(meth)acrylate, polyolefins, and polyesters or any combination thereof.

11. The method according to any one of claims 1 to 10, wherein the polymer particles comprise two or more different types of polymers.

12. A foam material produced by the method according to any one of claims 1 to 11.

13. The foam material according to claim 12, wherein the functional filler is GO and the foam material has an electrical conductivity of from 10⁻¹⁵ S.m⁻¹ to 10⁻⁵ S.m⁻¹.

14. The foam material according to claim 12, wherein the functional filler is rGO and the foam material has an electrical conductivity of from 0.001 S.m⁻¹ to 10,000 S.m⁻¹.

15. The foam material according to any one of claims 12 to 14, wherein the foam material has a compressive strength of from 0.5 kPa to 150 kPa.

16. The foam material according to any one of claims 12 to 15, wherein the foam material has a Young's modulus of from 1 kPa to 5000 kPa.

17. A foam material according to any one of claims 12 to 16, for use or when used in anti-static casings, electrode materials, support elements, insulators, catalysis, as membranes for water filtration, heat transfer materials, sound absorbing materials, implantable materials for biomedical engineering and electromagnetic interference shielding.

18. Use of a foam material according to any one of claims 12 to 16 in anti-static casings, electrode materials, support elements, insulators, catalysis, as membranes for water filtration, heat transfer materials, sound absorbing materials, implantable materials for biomedical engineering and electromagnetic interference shielding.
